(19) United States
(12) Patent Application Publication
(10) Pub. No.: US 2005/0260092 A1
(43) Pub. Date: Nov. 24, 2005

(54) Turbostatic compressor, pump, turbine and hydraulic motor and method of its operation

(76) Inventor: Stephen Rolfe Bolger, New York, NY (US)

Correspondence Address: REENA KUYPER, ESQ.;BYARD NILSSON, ESQ., 9255 SUNSET BOULEVARD, SUITE 810, LOS ANGELES, CA, 90069, US

(21) Appl. No.: 10/977,664

(22) Filed: Oct. 28, 2004

Related U.S. Application Data
(60) Provisional application No. 60/515,311, filed on Oct. 29, 2003.

(51) Int. Cl. F03C 2/00; F01B 29/10; F04C 2/00; F02G 1/04; F03C 4/00

(52) U.S. Cl. 418/142

(57) ABSTRACT

A variable-volume positive-displacement device configured to accommodate large flow volumes is disclosed. The variable-volume positive-displacement device despite being compact and lightweight, maintains pressure ratios of over 10 to 1 in a single stage operation. There is little loss of working fluid leakage, due to optimum sealing configurations and extremely low-seal sliding speeds. The device comprises a housing defining a closed chamber within opposing walls and a displacer mounted within the housing. The displacer maintains sliding contact with each of the inner wall surfaces of the chamber as it orbits and engages each of the inner wall surfaces in sequence. The volumes of the chambers surrounding the displacer vary as the displacer moves, depending on the position of the displacer. Working fluid is introduced into the chamber via inlet ports or is discharged via an outlet. This device may be used to replace conventional piston pumps, rotary pumps, scroll pumps, screw pumps, roots blowers, gear pumps and wankel displacers for pumping gases and liquids in applications requiring reduced frictional losses and tight sealing and relatively large displacement in a small volume. With integral valve-operators, the inventive device replaces turbines used for expansion of gases with large pressure ratios. This invention is particularly useful for constructing Brayton cycle engines and refrigerators. The inventive device offers improved operation and functional characteristics and lower cost of manufacture.

### RELATED APPLICATION INFORMATION

This application claims priority under 35 U.S.C. 120 to U.S. Provisional application Ser. No. 60/515,311 filed Oct. 29, 2003, which is hereby incorporated by reference as if set forth fully herein.

### BACKGROUND OF THE INVENTION

1. Field of the Invention

This invention relates generally to the field of mechanical devices used to perform compression, pumping, motoring, or expansion processes that are typically used in a myriad of different applications, for example, jet engines, refrigeration, air conditioning, etc. More particularly, the invention relates to a variable-volume positive-displacement device for performing compression, pumping, motoring, or expansion processes in any application that may require any one of these processes.

2. Background of the invention

Various compression, pumping, turbine and hydraulic mechanisms are well known and commonly used in many mechanical applications. To better appreciate the advantages of the variable-volume positive-displacement device in accordance with the invention and to understand its operation in some exemplary applications, some conventional engines and their operations and drawbacks are briefly described.

A piston engine comprises a tube or cylinder that holds a snugly fitting plug. The plug is free to move back and forth within this cylinder, pushed by pressure from hot gases. A rod is mounted to the moving plug and connects to a crankshaft, causing this crankshaft to rotate rapidly. The rod has a tendency to push the plug against the cylinder walls as it moves back and forth except when it is at the top or bottom of the cylinder and is aligned with the central point of the cylinder. Typically, a major disadvantage with this type of engine is that there is always substantial friction affecting the movement of the piston. In an aircraft engine, a propeller sits at the head of this crankshaft, spinning within the air. This type of piston engine powered all airplanes until the advent of later engines such as jet engines. Essentially, in a piston engine, the same volume of space (within the cylinder) alternately performs four different processes, those of intake, compression, combustion, and exhaust. Heat exchange between these processes reduces efficiency.

The Wankel rotary-piston internal-combustion engine has an equilateral triangular orbiting rotor. The rotor turns in a closed chamber and the three apexes of the rotor maintain a continuous sliding contact with the curved inner surface of the casing of the closed chamber. The curve-sided rotor forms three crescent-shaped chambers between its sides and the curved wall of the casing. The volumes of the chambers vary with the motion of the rotor.

In turning about its central axis, the Wankel engine rotor follows a circular orbit about the geometric center of the casing. The necessary orbiting rotation is achieved by means of a central bore in the rotor in which an internal gear is fitted to mesh with a stationary pinion fixed immovably to the center of the casing. The rotor is guided by fitting its central bore to an eccentric formed on the output shaft that passes through the center of the stationary pinion. This eccentric also harnesses the rotor to the shaft so that torque is applied when gas pressure is exerted against the rotor flanks as the fuel and air charges burn.

Maintaining pressure-tight joints by suitable seals at the apexes and on the end faces of the Wankel engine rotor is a major design problem due to very high sliding speeds. Radial sliding vanes are fitted in slots at the three apex edges and kept in contact with the casing by expander springs. The end faces of the rotor are sealed by arc-shaped segmental rings fitted in grooves close to the curved edges of the rotor and pressed against the casing by flat springs.

Engines built for airplanes had to produce plenty of power while remaining light in weight. At first, engines built for planes were similar to automobile engines that were heavy and complex because they used water-filled plumbing to stay cool. A rotary engine was introduced that adopted air cooling as a way to eliminate the plumbing and lighten the weight. The automobile type engines had been mounted firmly in supports, with the shaft and propeller spinning. One vintage rotary engine reversed that, with the shaft being held tightly and the engine spinning. Commonly, the engine is mounted firmly and the shaft turns. The propeller was mounted to the rotating engine, which stayed cool by having its cylinders whirl the open air. Although popular, rotary engines were limited in power, and ultimately lost favor.

After many other improvements along the way, designed to make engines more efficient and powerful, and improvements in fuel, jet engines conquered aviation. Jet engines commonly use the Brayton cycle. According to the principle of the Brayton cycle, air is compressed in a compressor. The air is then mixed with fuel, and burned under constant pressure in the combustor. The resulting hot gas is allowed to expand through a turbine to perform work. Most of the work produced in the turbine is used to run the compressor and the rest is available to run auxiliary equipment and produce power. The gas turbine is used in a wide range of applications. Common uses include stationary power generation plants (electric utilities) and mobile power generation engines (ships and aircrafts). A jet engine powered aircraft is propelled by the reaction of thrust of the exiting gas stream. The turbine provides just enough power to drive the compressor and produce the auxiliary power. The gas stream acquires more energy in the cycle than is needed to drive the compressor. The remaining available energy is used to propel the aircraft forward. While jet engines gave dramatic increases in speed, they showed poor fuel economy. Although fuel economy has improved over the years, it remains a concern.

typically, compressors and expanders used in jet engines must operate at high pressure ratios (at least a 10 to 1 ratio) and very high component efficiency (at least 90% efficiency), to reduce fuel consumption to practical levels. This is typically done with dynamical turbo devices involving high speed fluid flows in multiple small stages, limited by the need to avoid supersonic flows.

Compression techniques are also used in refrigeration, which is another application that is briefly described here. Most common refrigerators have four parts to the refrigeration system, a compressor, condenser, expansion valve, and evaporator. In the evaporator section, a refrigerant (e.g. Freon-12 or Ammonia or other materials developed to replace Freon-12) is vaporized and heat is absorbed through the inside wall of the refrigerator, making it cold inside. An electric motor runs a small piston or rotary-vane or scroll compressor to pressurize the refrigerant, which raises the temperature of the refrigerant. The resulting super-heated, high-pressure gas is then condensed to a liquid in an air-cooled condenser. In most refrigerators, the compressor is on the bottom and the condenser coils are on the rear of the refrigerator. From the condenser, the liquid refrigerant flows through an expansion valve, in which its pressure and temperature reduce the conditions that are maintained in the evaporator. The whole process operates continuously, by transferring heat from the evaporator section (inside the refrigerator) to the condenser section (outside the refrigerator) by pumping the refrigerant continuously through this system. When the desired temperature is reached, the pump stops and so does the heat transfer. Freezers and air conditioners work is a similar way. Accordingly, to the extent the invention is used in jet engines and refrigerators, it may also be used in other applications such as freezers and air conditioners.

Efforts are continuously being made to develop new engines that are more efficient, consume less fuel, and are less expensive to manufacture and operate. Even with respect to other applications such as those discussed above or any others requiring mechanical processes, more efficient methods and mechanisms are continuously sought.

### SUMMARY OF THE INVENTION

The device in accordance with the present invention is configured to achieve a positive displacement and variable volume during pumping or expansion processes. It can also be configured to minimize the dead volume ratio, making possible a volume as small as 1%. Large flow volumes are accommodated in the device that despite being compact and lightweight, maintains pressure ratios of over 10to 1 in a single stage of operation, with little loss of working fluid by leakage, due to optimum sealing configurations and extremely low seal- sliding speeds.

The device is configured to accommodate a displacer or rotor within a closed chamber with opposing walls formed within a housing. The displacer maintains sliding contact with each of the inner wall surfaces of the chamber as it orbits (rotational movement), engaging each of the inner wall surfaces in sequence. The rotational movement of the displacer causes a series of compartments that surround the displacer on its four sides (in the preferred embodiment) to vary in volume depending upon the position of the displacer. The working fluid is introduced into the chamber via an inlet and discharged via an outlet.

In accordance with one preferred embodiment of the inventive device, the displacer is mounted to a single crankshaft. Alternatively, in accordance with yet another preferred embodiment, the displacer is mounted to two tandem crankshafts.

The inventive device may be used to replace conventional piston pumps, rotary pumps, scroll pumps, screw pumps, roots blowers, gear pumps and wankel displacers for pumping gases and liquids in applications requiring reduced frictional losses, tight sealing, and relatively large displacement in a small volume. With integral valve-operators, the inventive device replaces turbines used for expansion of gases with large pressure ratios. This invention is particularly useful for constructing Brayton cycle engines and refrigerators. The inventive device offers improved operation, functional characteristics, and lower cost of manufacture.

Other advantages of the invention will become apparent and obvious from a study of the following description and the accompanying drawings, which are merely illustrative of the invention.

### BRIEF DESCRIPTION OF THE DRAWINGS

FIG. 1A is a perspective view of one preferred embodiment of the variable-volume positive-displacement device in accordance with the present invention using a single crankshaft;

FIG. 1B is a top lavational view of the embodiment with a single crankshaft, illustrating solid, fixed seals in the housing and compliant-vane-type tip seals on the displacer; including a partial cross sectional view of one of the valve mechanisms;

FIG. 2A is a schematic representation (cross sectional representation of only one) of the displacer or rotor within the housing of the variable-volume positive-displacement device using twin crankshafts instead of one (shown in FIG. 1), illustrating the manner in which the displacer is spaced from the inner wall of the housing at the initial stage of engagement when the device is performing a pumping or compression stroke;

FIG. 2B is a cross sectional side view of the displacer or rotor within the housing of the variable-volume positive-displacement device shown in FIG. 2A, illustrating the manner in which the displacer engages the inner wall of the housing at the conclusion of the pumping stroke (when the enclosed volume between the displacer and the inner wall is squeezed to a minimum);

FIG. 2C is a top view of a crankshaft link (to maintain two crankshafts rotating together) used in the twin crankshaft embodiment of the variable-volume positive-displacement device;

FIG. 2D is a top view of the twin crankshafts driven by the displacer in the variable-volume positive-displacement device;

FIG. 2E is a cross sectional side view of the variable-volume positive-displacement device shown FIG. 2D, taken along the line E-E;

FIG. 3A is a cross sectional view of the twin crankshaft embodiment of the variable-volume positive-displacement device (configured as a Brayton cycle engine), illustrated with two chambers and two displacers (one underneath the other as shown in dashed lines);

FIG. 3B is a side cross sectional view of the variable-volume positive-displacement device of FIG. 3A;

FIG. 4 is a schematic representation of a parallelogram linkage to hold the variable-volume positive-displacement device using a single shaft as illustrated in FIG. 1 in the required position.

FIG. 5A is cross sectional view of the variable-volume, positive-displacement device illustrated with three guide pins;

FIG. 5B is a cross sectional view showing the displacer being mounted to a base end plate; and

FIG. 6 is a schematic view illustrating the method of calculating the dimensions of the variable-volume positive-displacement device.

### DETAILED DESCRIPTION OF PREFERRED EMBODIMENTS

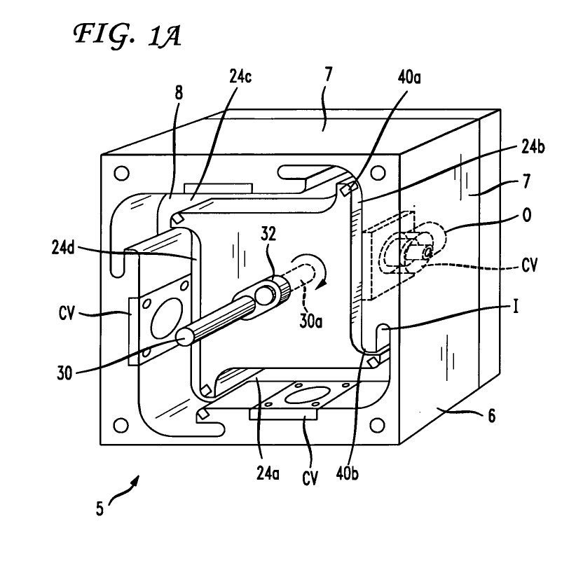

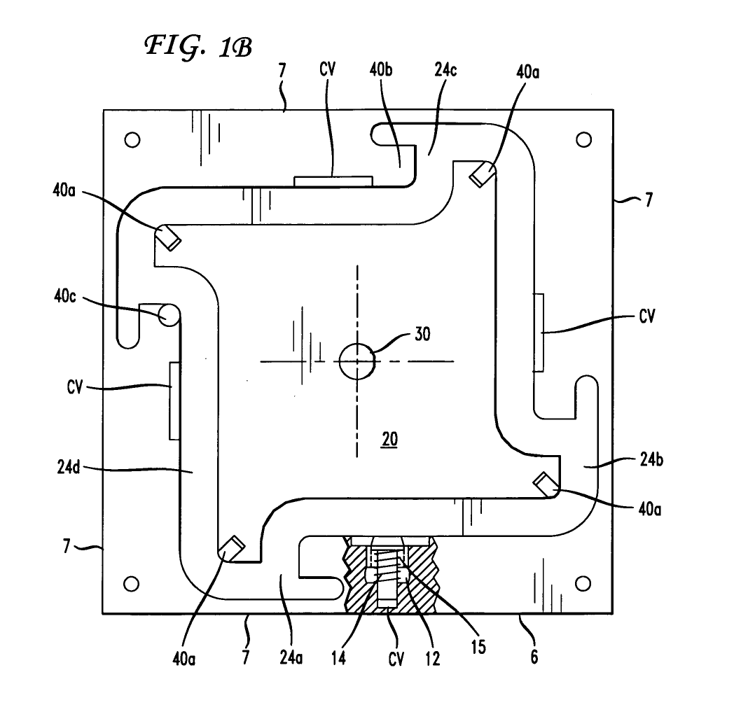

Referring now to FIGS. 1-6, some preferred embodiments of a variable-volume positive-displacement device 5 (also referred to as a “displacement device”) in accordance with the present invention are illustrated and described. The variable-volume positive-displacement device 5 differs from a conventional piston and cylinder. It resembles the Wankel engine. Like a turbine, it can be used only unidirectionally, to perform either compression and pumping or expanding and motoring processes. By minimizing friction and induction impedance, the variable-volume positive-displacement device 5 attains pumping efficiencies over 90% at pressure ratios of 10 to 1 in a single stage of operation, thereby facilitating construction of low-cost Brayton cycle engines. The invention combines compressing and expanding strokes on common shafts that displace fluids. The displacement of the expanding section may be enlarged with respect to the compressor to produce more shaft power. Alternatively, residual pressure remains in the exhaust to make a jet or drive an auxiliary turbine.

Although the device 5 is largely described here in connection with compressors and expanders of jet engines (for purposes of illustration), it may be used in many other applications. By way of another example, it may perform as an equally efficient hydraulic pump or motor. The unique configuration of the device 5 is easily formed by conventional fabrication techniques. For example, the device 5 may be machined, injection molded or extruded, and diced. Materials such as aluminum, titanium, steel, stainless steel ceramics, or plastic are preferable, but other similar types of materials may be substituted.

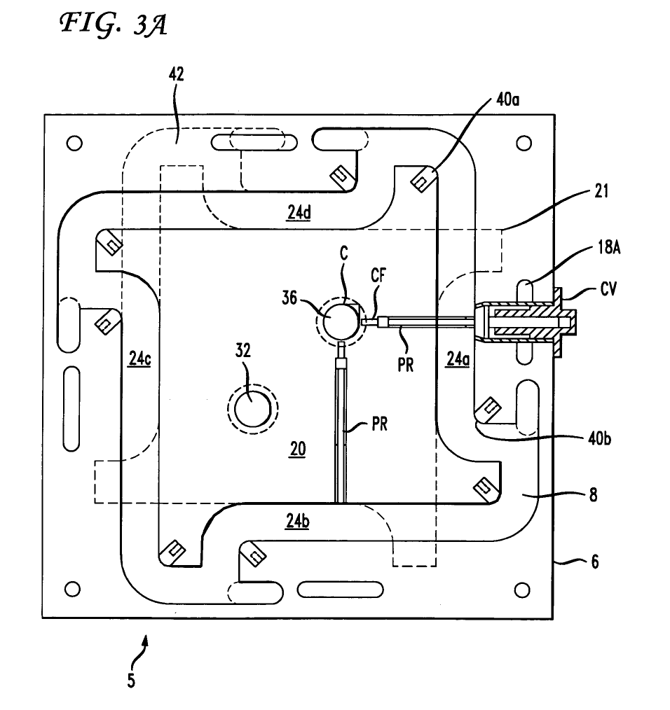

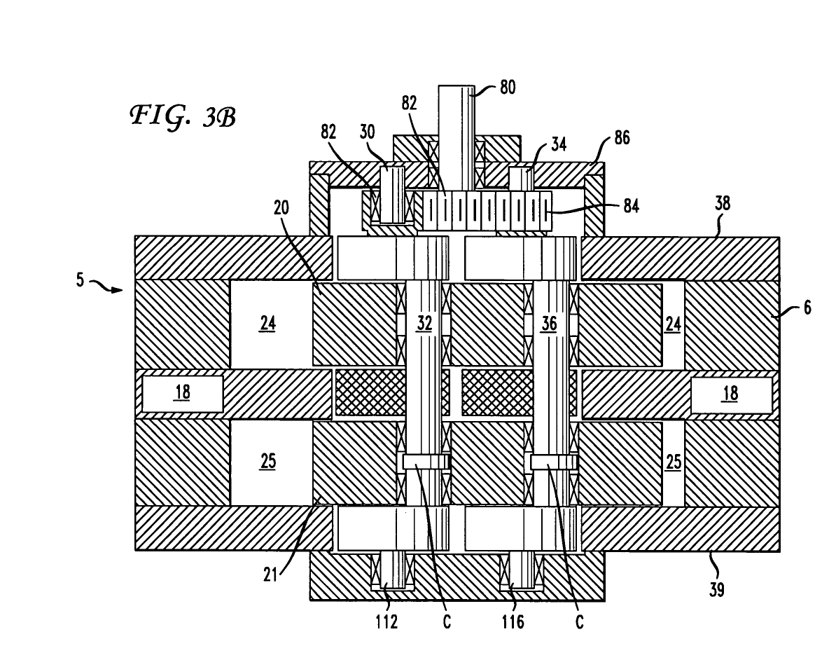

Referring now to FIG. 1A, the variable-volume positive-displacement device 5 is substantially square and comprises a housing or casing 6. The housing or casing 6 has four side walls, each indicated by reference numeral 7. The side walls 7 are mounted to a substantially planar base or end plate (shown best in FIG. 3B and indicated by reference numeral 38, described later and shown in FIG. 3B) with a displacer or rotor 20 located in the center of the device 5. The displacer 20 orbits within a closed chamber 8. Another cover or end plate (indicated by reference numeral 39, described later and shown in FIG. 3B) covers the housing 6 and is configured with openings to allow fluids to be introduced into the closed chamber 8.

In the configuration illustrated in Figure 1B, the closed chamber 8 comprises four spaces indicated by reference numerals 24a, 24b, 24c, and 24d, respectively. In this particular configuration, the spaces 24a, 24b, 24c, and 24d have equal volumes because the displacer or rotor 20 is shown, merely for dimensional purposes, as being centrally located. However, it should be recognized that when the displacer or rotor 20 is operating, it is never in the position that is illustrated in FIG. 1. The displacer 20 is always orbiting along the inner surfaces of the side walls 7 of the closed chamber 8. When the displacement device 5 is operating and the displacer 20 is orbiting, the displacer 20 comes in contact with each of the four sides in sequence. The displacer 20 moves from contact against one wall to the next, thereby compressing the spaces 24a, 24b, 24c, and 24d and varying the symmetrical volumes 24a, 24b, 24c, and 24d, in sequence.

To produce continuous pumping or motoring, the four symmetrical variable volumes 24a, 24b, 24c, and 24d are formed between the outer walls of the displacer 20 and the inner wall surfaces of the variable-volume positive-displacement device 5 (FIG. 1A). The displacer 20 has an eccentric 32 (a single eccentric) orbiting on a single crankshaft 30. The crankshaft 30 is mounted to the housing 6 on a crankpin 30a. On each of the side walls 7, the housing 6 is configured with a check valve mechanism CV and an inlet I through which fluids are introduced into the chamber 8. The check valve mechanism CV communicates with an outlet O through which the gases are discharged from the chamber 8. For illustration purposes, the check valve mechanism CV is shown (in dashed lines) on one side wall 7. Each of the side walls 7 is configured with the same type of check valve mechanism CV.

Referring now to Figures 1A and 1B, as noted above, the displacer or rotor 20 orbits eccentrically, compressing each of the four volumes 24a, 24b, 24c, and 24d in sequence during the span of a full orbit by the displacer 20. FIG. 1A shows the displacer 20 mounted eccentrically on the crankpin 30A as in the working device. At the position of the displacer 20 shown, one of the four pumping chambers (created within space 24b) is sealed and pumping, whereas the other three chambers (spaces 24a, 24c, 24d) are open to each other and to the intakes (not shown) on the cover endplate 39. The intakes may be circular holes formed on the cover endplate 39.

Each volume is enclosed by a tip seal 40a on a tip of the displacer 20, and at the other end by a complementary tip seal 40b on the corresponding tip on the wall of the device 5. Tip seals 40a are located at each of the four points of the displacer 20, and at each of the four corresponding corners of the stationary interior of the side walls 7 that face the displacer 20. For example, tip seals 40a and 40b are in contact with the opposing interior of the side wall 7 (i.e., opposing displacer surface), respectively, thereby sealing the variable volumes 24a, 24b, 24c and 24d, during compression. Each set of variable volumes 24a, 24b, 24c, and 24d varies as the displacer 20 engages the walls in this sequence as the shaft 30 rotates through an entire single orbit (360 degrees).

In the embodiment illustrated in FIG. 1B, the tip seals 40b are configured to be solid or fixed. During a pumping operation, the pumping force keeps the displacer 20 in a sliding (non-rotational) orientation against the fixed seal. By way of one example, the tip seals 40b may be integrally formed as part of the housing 6. The tips seals 40a on the displacer 20 are configured to be compliant or flexible to compensate for wear. By way of example, the tip seals 40a may be vane-type seals that are spring-loaded. In FIG. 1B, a roller fixed seal 40c is illustrated. This type of seal reduces overall friction.

FIG. 1B also illustrates an exemplary check valve mechanism CV. Of course, any other type known may be alternatively used to achieve the same purpose. The check valve mechanism CV consists of a plug 14 that slides within a fitting port 12 within a receptacle formed within the wall 7 of the housing 6. The plug 14 is biased against the seat of an opening that forms the outlet 0 by a spring 15.

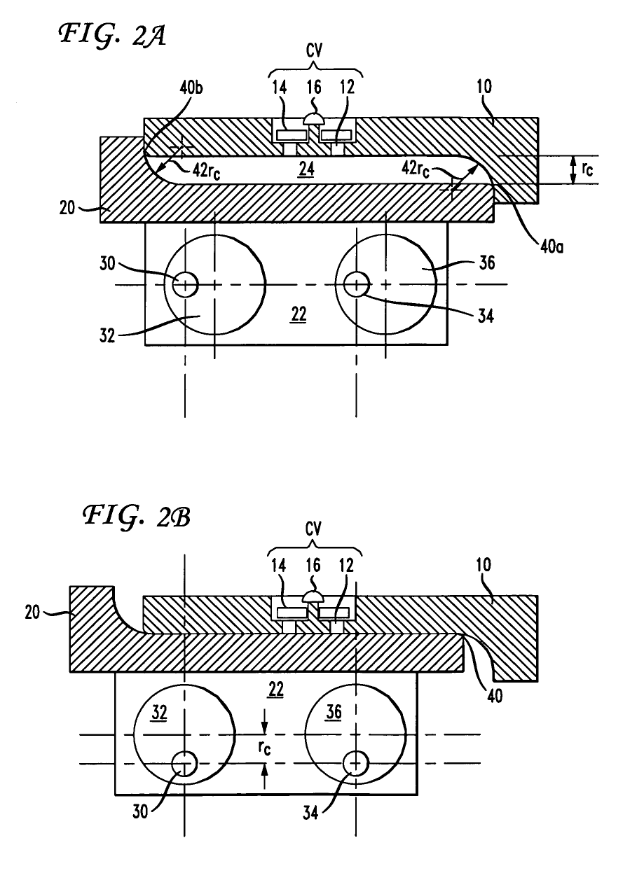

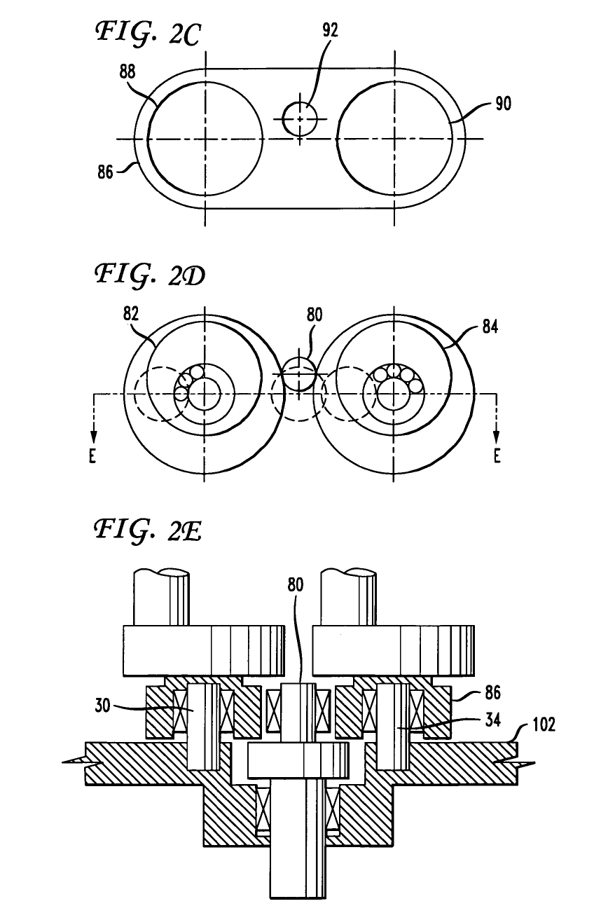

Referring now to FIGS. 2A and 2B, another embodiment of the inventive device, using tandem twin shafts, is described. FIGS. 2A and 2B show only one variable volume or chamber 24, in cross section, to illustrate configuration of a typical variable-volume formed in accordance with the invention. Two tandem crankshafts 30 and 34 turning together in this embodiment can reduce the frontal area of the device 5. The component configuration of FIG. 2A encloses a variable volume 24 contained between substantially rectangular L-shaped shoes, a first shoe 10 (a portion of one wall 7), and a second shoe 20 (a portion of the displacer 20). The volume is contained at the top and bottom by the two endplates (base and cover endplates not shown in this cross section, but otherwise indicated by reference numerals 38 and 39). The two shoes 10 and 20 are identical in shape and are arranged to face each other as shown in FIG. 2A.

Along the interior of each shoe (10 and 20) where the elongated end meets the shorter end is an engagement surface that has an identical engagement radius 42. At the other end of elongated end of the plate on the interior surface, is an engaging tip seal 40a. The two shoes 10 and 20 are configured such that their tip seals 40a and 40b slide along the inner engagement radius surface between the shoes 10 and 20 to form a sliding mechanical contact between the two shoes 10 and 20. Taking the example of one shoe, for example shoe 10, note that it is fixed in position to the two endplates (not shown in FIG. 2A as the end plates would be located above and below the cross section shown). The other shoe, for example shoe 20, has clearance for movement along a parallel plane to the end plates between them.

The shoe 20 moves in a non-rotational circular path, driven through a journal plate 22 by two eccentrics 32 and 36 running on the two shafts 30 and 34. The two shafts 30 and 34 rotate in tandem, in bearings through the endplates 38 and 39 (see FIG. 3B). A second set of eccentrics are preferably located on the same shafts (not shown) offset by 90 degrees to the first set of eccentrics 32 and 36, and linked by a second journal plate. This arrangement keeps the shafts 30 and 34 in tandem rotation. The variable volume 24 is enclosed by the tip seal 40a on the tip of the displacer 20 and at the other end by the tip seal 40b on the corresponding tip on the wall 7 of the device 5.

FIG. 2A depicts the variable volume at the initial stage of engagement for a pumping or compression stroke. The stroke takes place through 90 degrees of tandem shaft rotation to arrive at the state depicted in FIG. 2B in which the enclosed volume 24 has been squeezed to a minimum at the conclusion of the pumping stroke. For all but a small fraction of the remaining 270 degrees of shaft rotation, the volume is not sealed, because the two shoes 10 and 20 are disengaged and the tip seals 40a and 40b are not in contact with the opposing inner surfaces to the shoes 10 and 20. This disengagement provides for induction of the pumped fluid, and acts as the intake valve for the variable volume.

Check valve CV is shown in the fixed shoe 10. The discharge check valve CV has ports 12 sealed by a disk 14, which are retained by a pin 16 against the blast of the fluid as it is pumped.

During the 90 degrees of shaft rotation between the positions shown at Figures 2A and 2B, tip seals 40a and 40b move past engagement surfaces with engagement radii 42 on a corresponding circular path.

To ensure constant engagement of the tip seals 40a and 40b against the inner surfaces of the shoes 10 and 20, engagement radii 42 is the sum of the radius of crank eccentricity r_{c} and the radius of the tip seal 40b. The point of contact rotates through 90 degrees around the seal during the 90 degree turn of the rotor 20 during a compression stroke.

The variable-volume positive-displacement device 5 operates in the other direction as an expander or hydraulic motor when means are applied to operate a distribution valve according to the position of the cranks, in which case FIG. 2B depicts the initial position and FIG. 2A depicts the final position of the moving shoe 10 or 20 through a 90 degree expansion or motoring operation. The remaining 270 degrees of shaft rotation opens the variable volume for discharge.

Referring now to FIGS. 2C, 2D, and 2E, an alternative embodiment of the variable-volume positive-displacement device is described. In the alternative embodiment, twin tandem shafts 82 and 84 drive a central shaft 80 through a link 86 (see FIG. 2C). The shafts 82 and 84 are substantially cylindrical in configuration. The link 86 has complementary openings 88 and 90 to accommodate the twin shafts 82 and 84 as they move in an eccentric orbit. The link 86 also has a central shaft opening 92 that accommodates a central shaft 80. The link 86 as positioned over the twin shafts 82 and 84 and moves the central shaft 80 as it is moved by the twin shafts 82 and 84. In this way, the shafts 82 and 84 are linked for synchronous rotation. The tandem shafts 82 and 84 may be linked to move in synchronous rotation by any means, including an intermediate gear between gears on both shafts, or a second crank and link at 90 degrees to the cranks linked through the displacement device 5. Alternatively, a cogged timing belt or sprockets and chain may be used.

Brayton engines and refrigerators constructed according to the method disclosed here typically contain two pumping sections as shown in figure 1B, one of which has been flipped over and provided with valves, in a configuration with two displacers 20 on common shafts. Such a relationship is depicted in FIG. 3A. The section comprising the compressor has the usual check valves and the section comprising the expander has pushrods PR operated by cams C on the crankshafts to open similar valves when timely. In operation, as the crankshaft rotates, the cam C pushes against the pushrod PR, and opens the valve mechanism CV for a brief interval of time to allow the fluids to enter the chamber 24a. In the case of a hydraulic motor, the valve mechanism remains open for the entire duration of the movement of the displacer 20 through 90 degrees.

As in other Brayton engines, fuel is injected and burned between the compression and expansion stages. If the two sections have equal displacement, the residual pressure is expanded through a nozzle to produce a thrust in a jet engine. The residual pressure may also be converted to shaft work by a turbine. Alternatively, the expander can have a larger displacement than the compressor. The variable-volume principle behind the present invention is particularly beneficial in jet engines because its excellent seals, minimal dead volume, and extremely low friction allow the necessary component efficiencies over 90% to be easily attained. Also, this configuration accommodates a lot of displacement within a small volume in a device that weighs little. The extremely simple configuration may be easily fabricated from materials such as ceramics.

Referring now to FIG. 3A, the opposing or flipped-over relationship of one displacer 20 to the other dashed is shown by the outline of the displacer in the section not otherwise shown in the view. Shown in dashed lines, the symmetrical chamber 42 is a mirror opposite of the closed chamber 8 that is shown. The symmetrical chamber displacer 21 is therefore also a mirror opposite of the displacer 20.

Similar to Figures 1A and 1B, check valve CV allows fluid to enter (during volume expansion) and exit (during volume compression) the variable volume 24a. The check valve CV lies between the variable volume 24a and a port 18a.

As an alternative to the embodiment of FIGS. 1A and 1B, in the embodiment of FIGS. 3A and 3B, both displacers 20 and 21 are arranged around two tandem shafts 32 and 36. Shaft 32 and 36 incorporate cams C to open inlet valves through pushrods PR incorporated into the expander side displacer 20 only. The valve actuation process requires the displacer 20 to be orbiting and driven by the eccentrics through shafts 32 and 36. This places the pushrod PR corresponding to control valve CV immediately opposite each other at the top dead center position. At this precise position, cam C on shaft 36 (or 32 in the case of the two other of the four chambers) contacts cam follower CF pushing on the pushrod PR and opens the control valve CV for a brief period of time. Pumps, compressors, compound engines, and refrigerators can be balanced to a vibration-free state with counterweights on the shafts.

Referring now to FIG. 3B, a side cross sectional view of the variable-volume positive-displacement device 5 is illustrated. The side wall of the closed chamber 6 is shown between the two endplates, the top or cover endplate 38 and the bottom or base endplate 39. The displacer 20 is located in the top of the device 5 sharing common eccentric shafts 32 and 36 with the rotor 21 located separate and beneath the rotor 20, in the bottom of the device 5.

Variable volumes 24 are shown between the rotor 20 and side wall of the closed chamber 6. Similar symmetrical variable volumes 25, similar to the variable volumes 24 associated with the rotor 20, correspond to the rotor 21 and are shown between the rotor 21 and the side wall of the closed chamber 6. The fluid ports 18 are shown communicating between the compressing section 24 and the expanding section 25 within the walls of the closed chamber 6.

The eccentrics 32 and 36 are shown running through the rotors 20 and 21. Eccentrics 32 and 36 are attached at the top to the twin shafts 30 and 34, respectively. Eccentrics 32 and 36 are connected at the bottom to bearings 112 and 116, respectively, located in the bottom of the device 5. At the top of the device 5, the twin shafts 30 and 34 are connected to and drive a central shaft 80 by way gearing to maintain the two shafts 30 and 34 in tandem rotation. A gear 82 on the shaft 80 meshes with gears 84 and 86 on the respective shafts. The twin shafts 30 and 34 have cams C (FIG. 3A) that push against pushrods PR (FIG. 3A) as the shafts 30 and 34 rotate. The pushrods PR push against the valve mechanism CV causing it to open the valve for a brief interval of time.

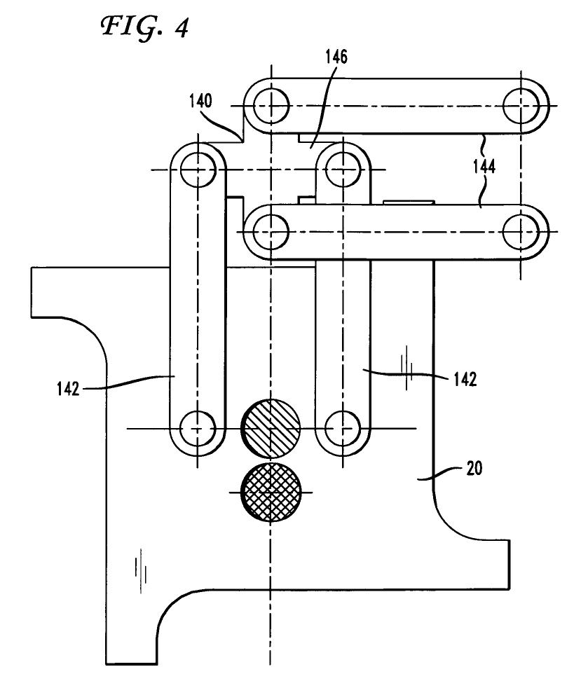

Referring now to FIG. 4, a parallelogram linkage indicated generally by reference numeral 140 is illustrated for use with the single crankshaft embodiment illustrated in FIG. 1. The parallelogram linkage 140 is similar to one used in a desk lamp and holds the displacement device 5 in the required position in an embodiment of the invention that only uses a single shaft 30. The parallelogram linkage 140 comprises vertical parallel components 142 that are staked to the displacer 20 and horizontal parallel components 144 that are staked to the housing 6 and linked by a connector component 146. The parallelogram linkage 140 keeps the displacer 20 from rotating and takes the load off the tip seals.

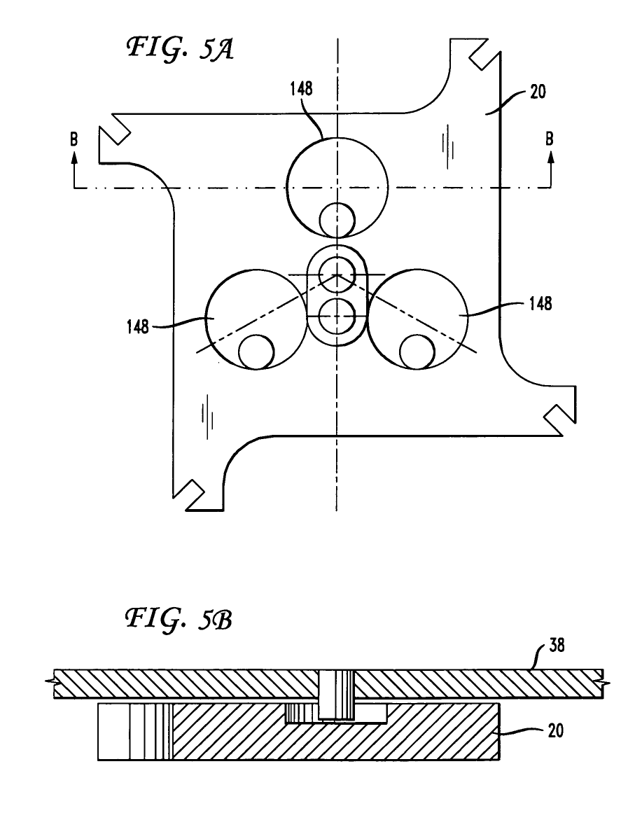

Referring now to FIGS. 5A and 5B, in accordance with another embodiment, the displacer 20 engages typically three guide pins 148 that track circular depressions 150 formed in the displacer 20. By using three guide pins 148, it can be assured that at least one of the guide pins 148 is properly positioned to block rotation of the displacer 20 for its full orbital motion. The guide pins 148 hold the displacer 20 in its non-rotational position when using compliant seals at both ends of the variable volumes 24. Alternatively, the guide pins 148 may be staked to the displacer 20 and the depressions 150 provided in the end plate 38 (not shown). The guide pins 148 are staked to the base end plate 38 as shown. The depressions 150 are formed such that the diameter equals two times the crank radius r_{c}plus the radius of the guide pin 148.

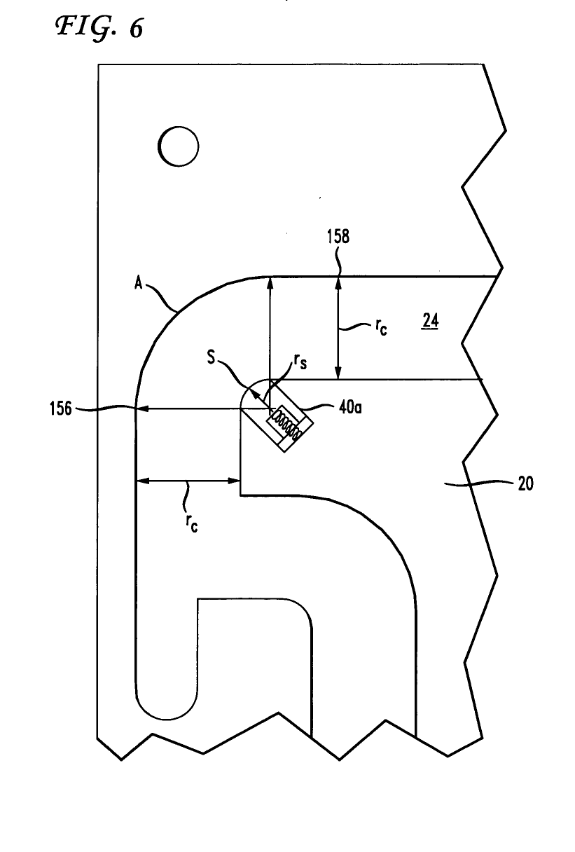

Referring now to FIG. 6, the mating surfaces of the displacer 20 and the interior of the wall 7 are shown in greater detail. The displacer 20 is shown in a centered position, the most useful position to use to choose starting and ending points for the mating surface arc A (the arc of contact of the seal 40a on the displacer 20 against the interior of the wall 7) from the corresponding points on the arc S of the seal 40a.

To design one of these devices one selects a desired crank radius r_{c} and other physical dimensions that will give the desired displacement. The seal arc S will typically be 10-25% of the crank radius r_{c}. The radius of the mating surface arc A will be the sum of the crank radius r_{c} and the seal radius rₛ. With the rotor centered, the mating surface arc A is then defined between the initial contact point 156 and final contact point 158, as indicated in FIG. 6. The length of the mating surface are A is equal to the crank throw from the corresponding points on the seal arc S.

In practice, there should be a little clearance between the displacer 20 and the housing 6 in the radial direction. This can be accomplished by reducing the crank radius r_{c} by the desired clearance. For example, if the crank radius r_{c} is chosen to be 0.625 inches and 0.005 inches of clearance are desired, the actual crank throw should be 0.620 inches. As the displacer 20 and housing 6 wear from that point, clearances will gradually increase. For this reason, the seal 40a, which must bear no force positioning the displacer 20, should be made as a vane. This may accommodate considerable wear, as well as give a little rebound capability to recover energy from the small volume of gas in the dead volume of the variable volume 24.

The two sealing surface arcs A that defining the two ends of each of the four variable volumes 24 need not be identical. But the sum of the seal radius rₛ and the crank radius r_{c} must be equal for both of the seals.

While preferred embodiments of the invention have been described herein, many variations are possible which remain within the concept and scope of the invention. Such variations would become clear to one of ordinary skill in the art after inspection of the specification and the drawings. The invention therefore is not to be restricted except within the spirit and scope of any appended claims.

1. An apparatus for accomplishing expanding, compression, pumping, motoring, or like processes, by displacing fluids, comprising:
a housing forming a closed chamber between four side walls;
a displacer mounted to the housing, the displacer on each of four sides having an elongated surface and a shorter surface extending substantially perpendicular from the elongated surface, each of the sides, engaging in sequence a complementary inner wall of the housing as the displacer moves in an orbit,
a variable volume chamber formed between the elongated and shorter surfaces of the displacer wall and the complementary inner wall of the housing;
at least one crankshaft for mounting the displacer to the housing;
a valve mechanism for introducing or discharging fluids to and from the variable volume chamber as the displacer moves along the orbit;
a port for introducing or discharging fluids to and from the variable volume chamber as the displacer moves along the orbit; and
a first seal located on the inner wall of the housing that periodically contacts the displacer, and a second seal located on the displacer that contacts the inner wall of the housing during the time that the first seal contacts the displacer, thereby ensuring minimal leakage of the fluids from within the variable volume chamber.

2. An apparatus according to claim 1, wherein the first seal is fixed to the housing.

3. An apparatus according to claim 2, wherein the first seal is integrally formed with the housing.

4. An apparatus according to claim 1, wherein the second seal is flexibly affixed to the displacer.

5. An apparatus according to claim 3, wherein the second seal is a vane-type seal that is biased by a spring to contact the inner wall.

6. An apparatus according to claim 1, further comprising:
a cam located proximate the crankshaft; and
a pushrod coupled to the valve mechanism such that rotation of the crankshaft causes the crankshaft to push the pushrod against the valve mechanism to allow the valve mechanism to open and permit entry of fluids.

7. An apparatus according to claim 1, further comprising: at least two plates that enclose the variable volume chamber at a bottom end and a top end of the housing.

8. An apparatus according to claim 7, wherein the displacer comprises at least one depression and the apparatus further comprises:
at least one guide pin affixed to one of the two plates, the guide pin configured to track the depression to assure proper movement of the displacer along its designated path.

9. An apparatus according to claim 1, wherein at least the housing and the displacer are fabricated from ceramics.

10. An apparatus according to claim 1, wherein at least the housing and the displacer are fabricated from a metal.

11. A method for displacing fluids to accomplish expanding, compression, pumping, motoring or like processes, comprising the steps of:
orbiting a displacer that has been mounted on an eccentric in a housing;
forming four variable chambers, in sequence, between sides of the displacer and side walls of the housing, during a full orbit of the displacer;
sealing each chamber in sequence, on one side, by moving a tip seal on the displacer portion that forms part of the chamber into contact with the inner wall of the housing that forms the other part of the chamber and, at the other end of the chamber, moving a tip seal on the inner wall of the housing that forms part of the chamber into contact with the displacer portion that forms the other part of the chamber;
introducing and discharging fluids to and from each of the variable volumes through a valve as the variable volumes seal, compress or expand; and
driving a crankshaft from the orbiting motion of the displacer.

12. A method according to claim 11, wherein the tip seal on the displacer portion is flexibly configured.

13. A method according to claim 11, wherein the tip seal on the inner wall is configured to be fixed.

14. An apparatus for accomplishing expanding, compression, or like processes, by displacing fluids, comprising:
a housing comprising a first, second, third, and fourth side walls that enclose a chamber within the walls;
a displacer positioned within the housing, the displacer comprising first, second, third, and fourth walls, each of the first, second, third, and fourth walls having an elongated section surface terminating in a shorter section surface, the shorter section surface extending substantially perpendicular from the elongated section surface, each of the elongated section surface and the shorter section surface configured to slide along and engage a complementary one of the first, second, third, or fourth walls of the housing, as the displacer moves in an orbit,
first, second, third, and fourth chambers formed between each of the elongated section surfaces and shorter surfaces of the displacer wall and the complementary inner wall of the housing, the chambers comprising varying volumes as the displacer moves along its designated path;
at least one crankshaft for positioning the displacer relative to the housing;
a valve mechanism for introducing or discharging fluids to and from the variable volume chamber as the displacer moves along the orbit;
a port for introducing or discharging fluids to and from the first, second, third and fourth chambers as the displacer moves along its designated orbit; and
seals located on the inner wall of the housing and the displacer, at least one of the seals configured to be fixed and at least one configured to be flexible to ensure minimal leakage of the fluids from within the chambers.

15. An apparatus according to claim 14, wherein the seal that is configured to be fixed is integrally formed with the housing.

16. An apparatus according to claim 14, wherein the seal configured to be flexible is a vane-type seal that is spring-loaded affixed to the displacer.

17. An apparatus according to claim 14, further comprising:
a cam located proximate the crankshaft; and
a pushrod coupled to the valve mechanism such that rotation of the crankshaft causes the crankshaft to push the pushrod against the valve mechanism to allow the valve mechanism to open and permit entry of fluids.

18. An apparatus according to claim 14, further comprising:
at least two plates that enclose the variable volume chamber at a bottom end and a top end of the housing.

19. An apparatus according to claim 14, wherein the displacer comprises at least one depression and the apparatus further comprises:
at least one guide pin affixed to one of the two plates, the guide pin configured to track the depression to assure proper movement of the displacer along its designated path.

20. An apparatus according to claim 14, wherein at least the housing and the displacer is fabricated from ceramics.

21. An apparatus according to claim 14, wherein at least the housing and the displacer is fabricated from a metal.
